(19) United States
(12) Patent Application Publication
(10) Pub. No.: US 2008/0150670 A1
(43) Pub. Date: Jun. 26, 2008

(54) Multi-layered symmetric helical inductor

(75) Inventors: Chul-ho Chung, Hwaseong-si (KR); Joo-hyun Jeong, Yongin-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/000,931

(22) Filed: Dec. 19, 2007

(30) Foreign Application Priority Data
Dec. 20, 2006 (KR) 10-2006-0131205

(51) Int. Cl. H01F 27/28; G01V 3/10; H01F 27/36

(52) U.S. Cl. 336/84 C; 336/180

(57) ABSTRACT

Provided is an inductor of a semiconductor device. The inductor may include a current entrance section, multiple layered ring-shaped conductive wires, and a via plug. Each of the ring-shaped conductive wires may be a helical type multi turn ring-shaped wire formed in one plane. The via plug may be connected to at least one of the ring-shaped conductive wires in order to transmit an electrical signal to another ring-shaped conductive wire.

### PRIORITY STATEMENT

This application claims priority under 35 USC § 119 to Korean Patent Application No. 2006-0131205, filed on Dec. 20, 2006, in the Korean Intellectual Property Office (KIPO), the entire contents of which are herein incorporated by reference.

### BACKGROUND

1. Field

Example embodiments relate to a multi-layered symmetric helical inductor.

2. Description of Related Art

An inductor, which is one of the unit circuit components of a RF device, takes up the largest area among the circuit components and also plays an important role in system performance. Because an inductor is the most difficult circuit component to be miniaturized among the unit circuit components, a challenge in improving the integration density of semiconductor devices having analog operations and/or inductors is presented. Because the size of other unit circuit components (e.g. transistor, resistor, and capacitor) becomes smaller as the density of the semiconductor device is increased, the circuit components can be more easily miniaturized. An inductor is not miniaturized by only shrinking the width and the length of the lines. For example, one of the typical methods used in obtaining a higher inductance in a given area is to increase the number of turns of the inductor. However, because an inductor having high inductance L needs proper line widths, proper space between the lines, and proper design considerations of patterns of other layers, implementing a high quality inductor is not trivial.

Two main factors in inductor performance are inductance L and quality factor Q. The definitions of inductance and quality factor are well known to those skilled in the art and therefore, omitted. In an inductor in a semiconductor device, the line length and the number of turns of the inductor affect the inductance. The quality factor is affected by the resistance of the line in a low frequency band, the signal loss of the substrate in a high frequency band, and by the symmetrical shape of the inductor. Therefore, in order to obtain a higher inductance, a longer line with many turns in as large of an area as possible, and a design that does not allow current to flow in different or opposite directions need to be implemented. In order to obtain a higher quality factor, a symmetrical conductive line having a low resistance in a substrate, which provides a smaller loss, needs to be implemented.

FIGS. 1A through 1C are perspective and plan views illustrating diverse shapes of inductors in a semiconductor device according to the conventional art.

Referring to FIG. 1A, an inductor 10 of a semiconductor device according to the conventional art is a multi layered rectangle-shaped single-turn inductor. The inductor 10 is comprised of plural unit inductors 11a, 11b, and 11c that are single-turned in one plane. The unit inductors are connected through vias 13a and 13b that connect to each layer. An end terminal of the inductor is connected to path line 15 through a via 13c that connects the lowest layer to the highest layer. The inductor 10 can increase inductance because of having the rectangle-shaped single-turn unit inductors in multiple layers. However, because the inductor is single-turned and not symmetrical, a decrease in the inductance due to mutual inductance may occur. Also, a differential type inductor cannot be implemented.

Referring to FIG. 1B, an inductor 20 of a semiconductor device according to the conventional art is a circle spiral multi-turn inductor formed in one plane. The inductor 20 is connected to a path line 25a formed in another plane through via 23a. The path line 25a is connected to another path line 25b formed in the same plane through via 23b. The inductor 20 can increase inductance in the same plane because it has a multi-turn structure, but inductance loss can not be inhibited due to current flowing in different and opposite directions. Also, quality factor Q is not easily increased because the inductor is not symmetrical.

Referring to FIG. 1C, inductor 30 of a semiconductor device according to the conventional art is implemented to have a symmetrical shape, a multi-turn, and a plurality of crossing sections 37a, 37b, and 37c in a plane. The inductor 30 illustrated in FIG. 1C is symmetrical, however the inductor 30 is not a helical type and the inductor 30 has a plurality of crossing sections 37a, 37b, and 37c. As a result, it is not easy to obtain a high inductance. Specifically, inductance loss occurs at the crossing sections 37a, 37b, and 37c and the manufacturing process is more complex because a single layer and the crossing sections 37a, 37b, and 37c need to be formed in three dimensions at the same time.

Therefore, due to the trend of high integration of semiconductor devices, inductors that have a higher inductance and a higher quality factor in a small area need to be developed.

### SUMMARY

Example embodiments provide an inductor including a ground shield pattern which may have a higher inductance and a higher quality factor in a smaller area.

According to example embodiments, an inductor of a semiconductor device may include a current entrance section, multiple layered ring-shaped conductive wires, and a via plug. Each of the ring-shaped conductive wires may be a helical type multi-turn ring-shaped wire formed in one plane. The via plug may be connected to at least one of the ring-shaped conductive wires in order to transmit an electrical signal to another ring-shaped conductive wire.

### BRIEF DESCRIPTION OF THE DRAWINGS

Example embodiments will be more clearly understood from the following detailed description taken in conjunction with the accompanying drawings. FIGS. 1A-4 represent non-limiting, example embodiments as described herein.

FIGS. 1A through 1C are perspective and plan views illustrating diverse shapes of inductors in a semiconductor device according to the conventional art.

FIG. 2A is a perspective view illustrating an inductor according to example embodiments;

FIG. 2B is a plan view illustrating unit inductors according to example embodiments;

FIG. 2C is a cross-sectional view illustrating an inductor according to example embodiments;

FIG. 2D is a cross-sectional view illustrating an inductor according to example embodiments;

FIGS. 3A through 3C are plan views illustrating ground shield patterns according to example embodiments; and

FIG. 4 is a cross-sectional view illustrating a ground shield pattern according to example embodiments.

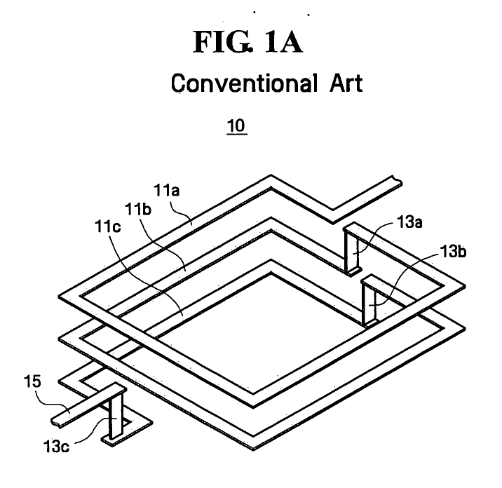

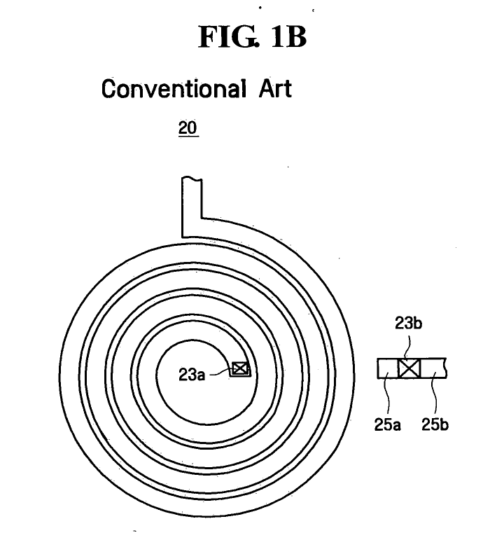

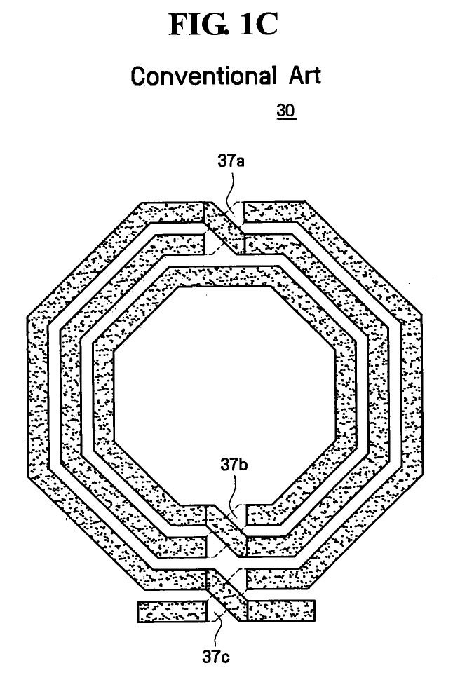

### DETAILED DESCRIPTION OF EXAMPLE EMBODIMENTS

Reference will now be made in detail to example embodiments, examples of which are illustrated in the accompanying drawings. However, example embodiments are not limited to the embodiments illustrated hereinafter, and the embodiments herein are rather introduced to provide easy and complete understanding of the scope and spirit of example embodiments. In the drawings, the thicknesses of layers and regions are exaggerated for clarity.

It will be understood that when an element or layer is referred to as being “on,” “connected to” or “coupled to” another element or layer, it may be directly on, connected or coupled to the other element or layer or intervening elements or layers may be present. In contrast, when an element is referred to as being “directly on,” “directly connected to” or “directly coupled to” another element or layer, there are no intervening elements or layers present. Like reference numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” may encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle may, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

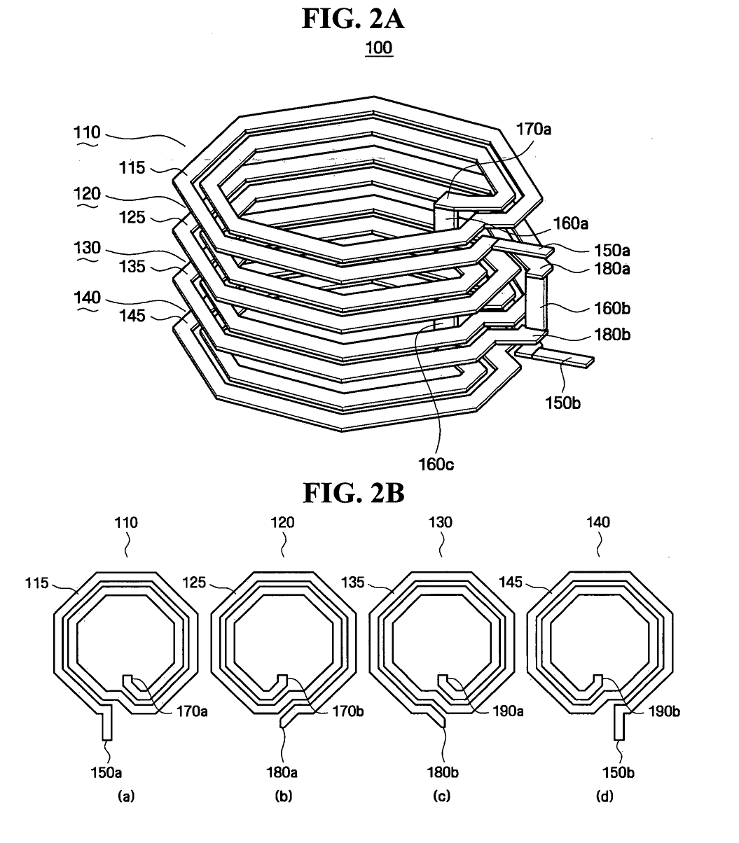

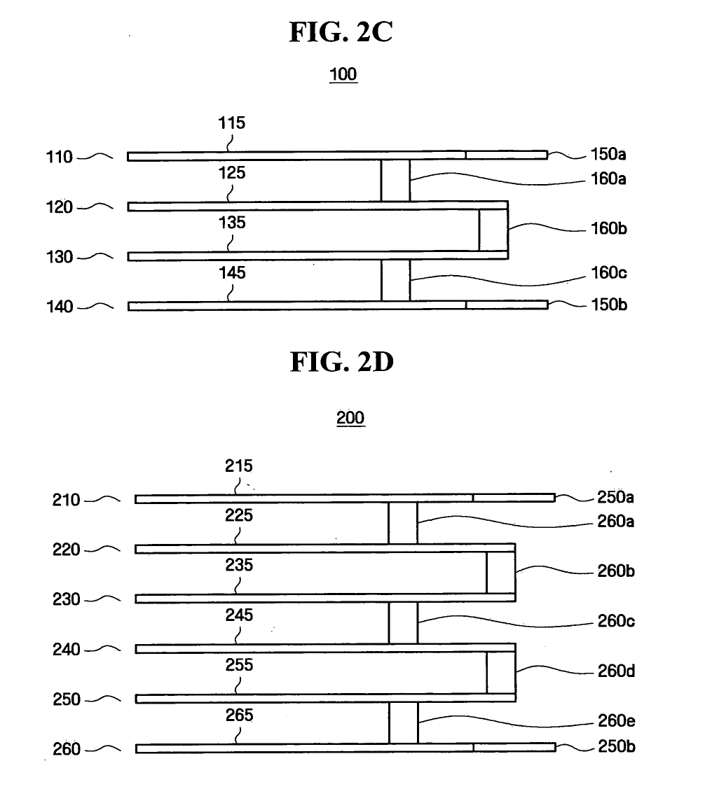

Referring to FIG. 2A, an inductor 100 according to example embodiments may be formed by stacking unit inductors 110, 120, 130, and 140 implemented to form a symmetrical helical shape multi-turn in multiple layers. Example embodiments illustrate the inductor 100 formed with four layers, but the inductor 100 may not be limited to such illustration. In other words, the inductor 100 may be formed with two layers or it may be formed with more than four layers, for example. Specifically, the unit inductors 110, 120, 130, and 140 formed in one plane may have a symmetrical shape and may have helical multi-turns. Example embodiments illustrate the unit inductors having two multi-turns. However, the unit inductors may not be limited to having two multi-turns and may be implemented to have more than two multi-turns.

An inductor has a symmetrical shape if based on the centerline of the inductor the number of turns on opposite sides are the same. Example embodiments illustrate an inductor having two turns.

Each unit inductor 110, 120, 130, and 140 may include current entrance sections 150a and 150b, ring-shaped conductive wires 115, 125, 135, and 145, via plugs 160a, 160b, and 160c, and via pads 170a, 180a, and 180b.

The current entrance sections 150a and 150b may be formed to be electrically connected to the end sections of the ring-shaped wires 115 and 145 of the lowest and the highest unit inductors 110 and 140.

The ring-shaped conductive wires 115, 125, 135, and 145 may be formed to have multi-turns. The current entrance sections 150a and 150b, through via pads 170a, 180a, and 180b, may be connected with or formed on the end section of an outermost turn and an innermost turn.

The ring-shaped conductive wires 115 and 135 formed on odd layers may be in a mirroring configuration with respect to the ring-shaped conductive wires 125 and 145 formed on even layers. The mirroring configuration means a right left change without an up down change, or an up down change without a right left change (e.g., a shape reflected in a mirror).

The via plugs 160a, 160b, and 160c may be vertical structures electrically connected to the end of the ring-shaped conductive wires 115, 125, 135, and 145 of the unit inductors 110, 120, 130, and 140 to electrically connect the unit inductors 110, 120, 130, and 140 formed on the different layers.

The via pads 170a, 180a, and 180b may be electrically connected to the ring-shaped conductive wires 115, 125, 135, and 145 and the via plugs 160a, 160b, and 160c, and may be considered as extended portions of the ring-shaped conductive wires 115, 125, 135, and 145. The plane size of the via pads 170a, 180a, and 180b may be formed larger than the sectional plane size of the via plugs 160a, 160b, and 160c. The manufacturing process margin may be increased if the plane size of the via pads 170a, 180a, and 180b are larger than the sectional plane size of the via plugs 160a, 160b, and 160c.

In FIG. 2A, only three of the via pads 170a, 180a, and 180b are shown and thus, the other via pads are not shown. The components that are not shown and not explained with reference to FIG. 2A will be described in the following drawings.

As illustrated in FIG. 2A, the inductor 100 according to example embodiments may be capable of obtaining a higher quality factor because the inductor 100 may be formed in a symmetrical shape. Because the inductor 100 may be implemented to have multi-turns and may be formed in multiple layers, the inductor 100 may also be capable of obtaining a higher inductance in a smaller area.

The directions of the current in the via plugs 160a, 160b, and 160c may be identical and thus, there may be less or no loss of inductance and the inductor 100 may be used as a differential inductor.

The inductor 100 may also be formed in an octagonal shape. Typically, the inductor of a semiconductor device is formed in a rectangular or a circular shape. The simplest method may be to form the inductor in a rectangular shape, but in this case it may be difficult to obtain a higher L factor. On the other hand, forming an inductor in a circular shape may have a disadvantage of a more complex manufacturing process. However, an inductor may be formed in an octagonal shape to have a more similar shape to a circle. It may be more simple to manufacture an inductor having an octagonal shape because the angle of an oblique line of an octagon is 45 degrees. Plan views (a) through (d) of FIG. 2B illustrate the unit inductors 110, 120, 130, and 140 of the inductor 100 according to example embodiments.

Referring to (a) of FIG. 2B, the first unit inductor 110 formed on the top layer may include the first current entrance section 150a, the first ring-shaped conductive wire 115, and the first via pad 170a.

The first current entrance section 150a may be used to introduce current to the inductor 100. The first ring-shaped conductive wire 115 may be formed to have multi-turns and may generate unit inductance. As shown in the drawings, the unit inductors 110, 120, 130, and 140 may be symmetrical from top to bottom and from right to left.

The first via pad 170a may be connected to the first via plug 160a (of FIG. 2A), which may be electrically connected to the unit inductor 120 forming a second layer. The first via pad 170a may be formed on the inside of the first ring-shaped conductive wire 115.

Referring to (b) of FIG. 2B, the second unit inductor 120 may form the second layer of the inductor 100 and may be composed of the second via pad 170b, which may be electrically connected to the first via plug 160a (of FIG. 2A), the second ring-shaped conductive wire 125, and the third via pad 180a.

The third via pad 180a may be formed on the outside of the second ring-shaped conductive wire 125. In other words, the third via pad 180a may be formed outside of the second ring-shaped conductive wire 125 to be symmetrical to the second via pad 170b formed on the inside of the second ring-shaped conductive wire 125.

Referring to (c) of FIG. 2B, the third unit inductor 130 may form the third layer of the inductor 100 and may include the fourth via pad 180b, which may be electrically connected to the second via plug 160b (of FIG. 2A), the third ring-shaped conductive wire 135, and the fifth via pad 190a.

The third unit inductor 130 may include the fourth via pad 180b formed on the outside of the third ring-shaped conductive wire 135 and the fifth via pad 190a formed on the inside of the third ring-shaped conductive wire 135.

Referring to (d) of FIG. 2B, the fourth unit inductor 140 may form the fourth layer of the inductor 100 and may include the sixth via pad 190b, which may be electrically connected to the third via plug 160c (of FIG. 2A), and the second current entrance section 150b.

FIG. 2C is a cross-sectional view illustrating the inductor 100 according to example embodiments.

Referring to FIG. 2C, unit inductors 110, 120, 130, and 140 including ring-shaped conductive wires 115, 125, 135, and 145 may be formed in four layers. The unit inductors may be electrically connected through the via plugs 160a, 160b, and 160c. The unit inductor 110 forming the highest layer and the unit inductor 140 forming the lowest layer may include the current entrance sections 150a and 150b, respectively.

FIG. 2D is a cross-sectional view illustrating an inductor 200 according to an example embodiment for comparison with the inductor 100 illustrated in FIG. 2C.

Referring to FIG. 2D, the inductor 200 illustrates that unit inductors 210, 220, 230, 240, 250, and 260 may be formed in six layers. The inductor 200 also illustrates an example of the various shapes that may be implemented using the technical concepts of example embodiments.

The unit inductors 210, 220, 230, 240, 250, and 260 may include ring-shaped conductive wires 215, 225, 235, 245, 255, and 265, respectively, and may be electrically connected through via plugs 260a, 260b, 260c, 260d, and 260e, respectively.

The unit inductor 210 forming the highest layer and the unit inductor 260 forming the lowest layer may include current entrance sections 250a and 250b, respectively.

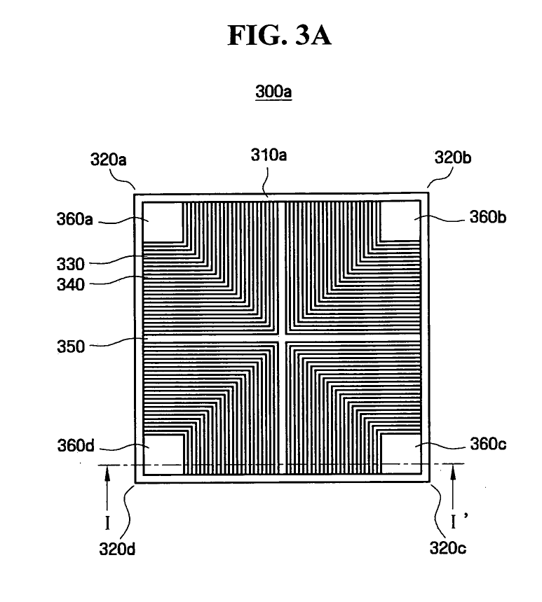

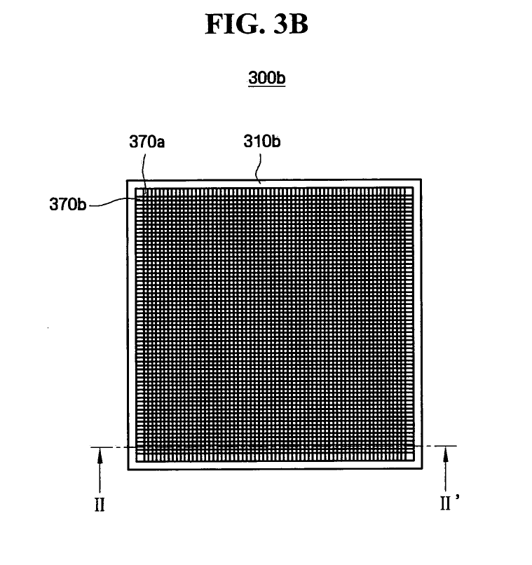

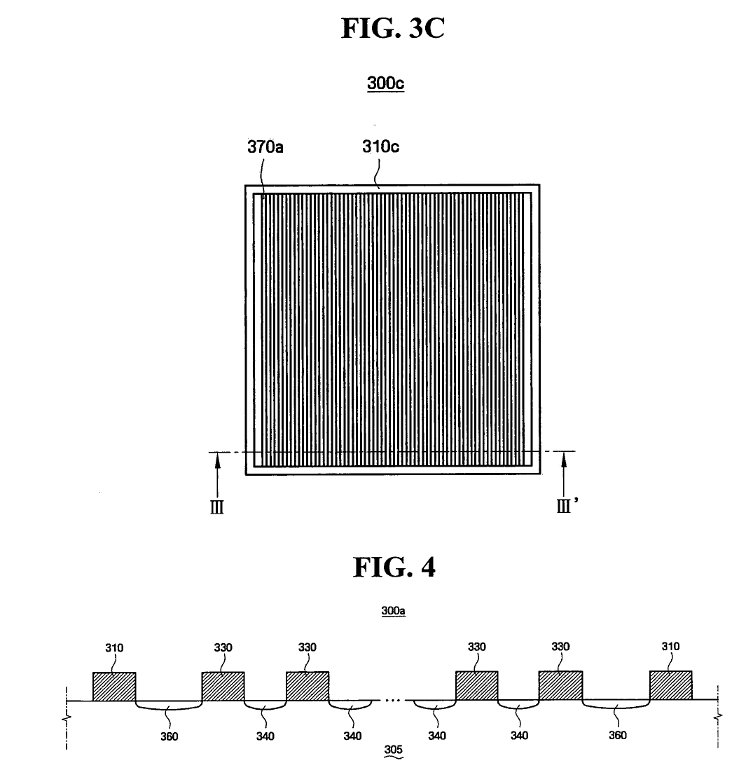

FIGS. 3A through 3C are plan views illustrating ground shield patterns according to example embodiments. Because an inductor according to example embodiments may be formed in multiple layers, the inductor may be formed closer to the substrate of a semiconductor device than an inductor formed according to conventional methods. Also, in order for the inductor according to example embodiments to obtain maximum inductance, eddy current must be reduced. Therefore, according to example embodiments, eddy current may be reduced by forming the ground shield pattern under the inductor.

Referring to FIG. 3A, the ground shield pattern 300a according to example embodiments may include a square ground line 310a formed under the inductor, L-shaped unit shield patterns 320a, 320b, 320c, and 320d, which may be electrically connected to the ground line 310a. Because the unit shield patterns 320a, 320b, 320c, and 320d may be in a L shaped pattern, surface exposed areas of the substrate 360a, 360b, 360c, and 360d may be formed in the corners connected to the ground line 310a.

The unit shield patterns 320a, 320b, 320c, and 320d may include multiple unit shield lines 330. The unit shield lines 330 may be formed with conductive material, for example, polysilicon. Each of the unit shield lines 330 may be formed in a protruding shape. A cross-sectional view of each of the unit shield lines 330 taken along line I-I′ will be later described in reference to FIGS. 3B-4.

The ground shield pattern 300a may be directly formed on the substrate of a semiconductor device, for example, a silicon substrate. The ground line 310a may be electrically connected to the ground electrode (not shown) of the semiconductor device.

Referring to FIG. 3B, a ground shield pattern 300b according to example embodiments may include shield lines 370a and 370b formed in a mesh shaped pattern. The vertical shield line 370a and the horizontal shield line 370b may be crossed and may be formed in a protruding shape. The cross-sectional view of the vertical shield line 370a taken along line II-II′ of FIG. 3B is in reference to the cross-sectional view taken along line I-I′ of FIG. 3A.

Referring to FIG. 3C, a ground shield pattern 300c according to example embodiments may include shield lines 370a formed in a bar shaped pattern.

The bar-shaped shield lines 370a may be formed in a horizontal direction or in a vertical direction. The cross-sectional view of the bar-shaped shield lines 370a taken along line III-III′ of FIG. 3C is in reference to the cross-sectional view taken along line I-I′ of FIG. 3A.

The ground shield patterns 300a, 300b, and 300c according to example embodiments may be formed on the bottom of the inductor and may provide the inductor with maximum inductance by blocking eddy current of the inductor.

FIG. 4 is a cross-sectional view illustrating the ground shield pattern according to example embodiments. Specifically, FIG. 4 is the cross-sectional view taken along I-I′ of FIG. 3A and also may be considered as cross-sectional views taken along lines II-II′ of FIG. 3B and III-III′ of FIG. 3C.

Referring to FIG. 4, the ground shield pattern 300a according to example embodiments may include multiple conductive unit shield lines 330 formed on a semiconductor substrate 305.

The unit shield lines 330 may be formed in a protruding shape. The surface of the semiconductor substrate 305 may be exposed in the area between the unit shield lines 330. The area between the unit shield lines 330 may be a conductive area 340 due to impurity doping. The unit shield line 330 may be formed with polysilicon.

Although the ground shield pattern 300 may be directly formed on the semiconductor substrate 305, the ground shield pattern 300 may not necessarily be formed directly on the substrate 305. For example, the substrate 305 may be an area where other unit semiconductor circuit components (e.g., transistor, capacitor, and conducting line) may be formed.

The ground shield patterns 300a, 300b, and 300c according to example embodiments may more effectively reduce or prevent eddy current generated by an inductor. Ground shield patterns in other shapes are not excluded and ground shield patterns in other shapes may be combined with the inductor according to example embodiments.

As described above, the inductor according to example embodiments may have one or more of the following effects.

Because the inductor may be formed symmetrically, a higher quality factor may be obtained. Because the inductor may be formed in multiple layers and may have multi-turns, a higher inductance in a smaller area may be obtained. Because the current direction of the via plugs may be identical, inductance loss may not occur and the inductor may be used as a differential inductor. Because the inductor may be formed in an octagonal shape, the manufacturing process may be simpler.

The foregoing is illustrative of example embodiments and is not to be construed as limiting thereof. Although example embodiments have been described, those skilled in the art will readily appreciate that many modifications are possible in example embodiments without materially departing from the novel teachings and advantages of example embodiments. Accordingly, all such modifications are intended to be included within the scope of the claims. Therefore, it is to be understood that the foregoing is illustrative of example embodiments and is not to be construed as limited to the specific embodiments disclosed, and that modifications to the disclosed embodiments, as well as other embodiments, are intended to be included within the scope of the appended claims. Example embodiments are defined by the following claims, with equivalents of the claims to be included therein.

What is claimed is:

1. An inductor of a semiconductor device comprising:
at least one current entrance section;
a plurality of multiple layered ring-shaped conductive wires, each of the ring-shaped conductive wires being a helical type multi-turn ring-shaped wire and formed in one plane; and
at least one via plug connected to at least one of the ring-shaped conductive wires for transmitting an electrical signal to another ring-shaped conductive wire.

2. The inductor of claim 1, wherein the ring-shaped conductive wires include at least one via pad to electrically connect to the at least one via plug.

3. The inductor of claim 2, wherein the at least one via pad is formed on one of end sections of the ring-shaped conductive wires.

4. The inductor of claim 3, wherein the at least one via pad is larger than the at least one via plug.

5. The inductor of claim 2, wherein each of the via pads is formed on both end sections of the ring-shaped conductive wires.

6. The inductor of claim 5, wherein one of the via pads is formed on the inside of the ring-shaped conductive wires and another via pad is formed on the outside of the ring-shaped conductive wires.

7. The inductor of claim 2, wherein the number of via pads of each of the uppermost ring-shaped conductive wire and the lowermost ring-shaped conductive wire is one.

8. The inductor of claim 7, wherein the at least one current entrance section is formed on the opposite end section of the section in which the via pad is formed on.

9. The inductor of claim 1, wherein current direction of the via plugs are identical.

10. The inductor of claim 1, wherein the ring-shaped conductive wires are formed in an octagonal shape.

11. The inductor of claim 1, wherein the ring-shaped conductive wires are formed in a symmetrical shape.

12. The inductor of claim 11, wherein the shapes of the ring-shaped conductive wires forming odd layers are identical and the shapes of the ring-shaped conductive wires forming even layers are identical.

13. The inductor of claim 11, wherein the ring-shaped conductive wires forming odd layers are in a mirroring shape with respect to the ring-shaped conductive wires forming even layers.

14. The inductor of claim 1, wherein the number of layers of ring-shaped conductive wires is even.

15. The inductor of claim 1, further comprising:
a ground shield pattern under the ring-shaped conductive wires.

16. The inductor of claim 15, wherein the ground shield pattern includes L-shaped unit shield patterns formed in a square ground line.

17. The inductor of claim 16, wherein the L-shaped unit shield patterns are formed in a symmetrical shape.

18. The inductor of claim 15, wherein the ground shield pattern includes a mesh shaped unit shield pattern formed in a ground line.

19. The inductor of claim 15, wherein the ground shield pattern includes a bar shaped unit shield pattern formed in a ground line.

20. The inductor of claim 15, wherein the ground shield pattern includes a protruding shaped unit shield pattern.
